(19) United States
(12) Patent Application Publication
(10) Pub. No.: US 2017/0365429 A1
(43) Pub. Date: Dec. 21, 2017

(54) METHOD FOR ADJUSTING A MAGNETIC RELEASE MECHANISM

(71) Applicant: Johnson Electric S.A., Murten (CH)

(72) Inventors: Matthias Kulke, Dresden (DE); Christian Urban, Dresden (DE); Jörg Schierz, Steinigtwolmsdorf (DE)

(21) Appl. No.: 15/624,151

(22) Filed: Jun. 15, 2017

(30) Foreign Application Priority Data
Jun. 15, 2016 (DE) 10 2016 110 979.7

(51) Int. Cl. H01H 47/02; H01H 50/18

(52) U.S. Cl. CPC H01H 47/02; H01H 50/18

(57) ABSTRACT

A method for adjusting a magnetic release mechanism includes steps: a first measurement of the present release current I of the magnetic release mechanism is carried out, a decision is made as to whether an adjustment step is performed, a start-adjustment current I_{J0} is selected, a second measurement of the present release current I of the magnetic release mechanism is carried out, a decision is made as to whether an adjustment step is performed and that in the event that an adjustment step is necessary, a selection of a certain differential amount ΔI_{J} takes place, partial demagnetisation of the permanent magnet is carried out in a further adjustment step with the adjustment current I_{J} formed in this way and the steps are carried out in succession until the release current I measured lies within a specified range between I_{TARGET}_{_}ₘᵢₙ and I_{TARGET}_{_}ₘₐₓ.

### CROSS REFERENCE TO RELATED APPLICATIONS

This non-provisional patent application claims priority under 35 U.S.C. §119(a) from Patent Application No. 10 2016 110 979.7 filed in Germany on Jun. 15, 2016.

### FIELD OF THE INVENTION

The present invention relates to the field of adjusting method, and in particular to a method for adjusting a magnetic release mechanism.

### BACKGROUND OF THE INVENTION

In order, for example, to protect electrical and electronic assemblies, provision is made to arrange a controllable circuit breaker in a supply line providing supply voltage to the assembly. This circuit breaker, which may also be designed as a power circuit breaker for high currents, should, in the event of a fault where for example a short circuit has occurred, interrupt the supply voltage line and thereby protect the assembly. Such breakers are usually executed by means of a bimetal or a magnet and a coil.

Use is made for example of permanent magnets, by means of which an armature can be held permanently in a first position in which mechanical switching contacts connected to the armature are closed. The line—to be activated—of a circuit is connected to these switching contacts. In order to interrupt the switching contacts and hence also the current flow in the circuit, a coil, for example, is provided which, controlled by a sufficiently strong current flow, generates a magnetic field which at least weakens the magnetic field of the permanent magnet and in this way makes it possible to move the armature and hence the switching contacts, for example using the power of a taut spring element, out of their closed position into an open position.

Such circuit breakers working on the magnetic principle are also called ‘magnetic release mechanisms’. The invention relates in particular to magnetic release mechanisms used in power circuit breakers. With such magnetic release mechanisms there is a demand for release when a low level of release energy is used, which brings the magnetic switch out of the “closed” state into an “open” state. Here, with a closed magnetic release mechanism a flow of current is enabled, whilst with an open magnetic release mechanism the flow of current is interrupted.

An interruption or switching-off process of a magnetic release mechanism is for example generated with the aid of a current flowing through a coil, which is a short-circuit current or correspondingly high current flowing in the event of a short circuit, in which the magnetic release mechanism should release and interrupt the circuit.

In order, in the event of a short circuit, to protect components, assemblies or devices from the destructive impact of too large a current, it is necessary for an interruption of the relevant circuit by the magnetic release mechanism to occur very fast, within a few milliseconds.

As a result of variations during the production of the magnetic release mechanisms, in particular of the permanent magnets, which during normal operation are supposed to guarantee the closure of the switch in the magnetic release mechanism, a release energy of differing magnitude, i.e. a release current of differing magnitude, is required to trigger the magnetic release mechanism. In addition, it may be the case that the required release current has to be very large in order to ensure the reliable release of the magnetic release mechanism.

For standardised use of magnetic release mechanism in practice, it is provided that the magnetic release mechanisms are adjusted in respect of their release energy, specifically, their release current, and in this way the required release current lies in a specified tolerance range. Here, the term ‘adjustment’ is used to mean as an exact a setting as possible of a parameter, for example of a release current I of a magnetic release mechanism, by a person skilled in the art. In this Description this adjustment process take place on a ready-mounted magnetic release mechanism assembly without having to open this to perform the method for adjusting the magnetic release mechanism.

In the prior art these adjustment process take place in the form of a mechanical or magnetic adjustment of the magnetic release mechanism.

From CA 000002271327 A1 an actuation arrangement for opening a switch, or a circuit interruption contact, is known which interrupts the current in the event that excess current is present.

It is disclosed that the actuation arrangement for the electrical power switching device has a mechanical calibration tool by means of which, advantageously, the calibration of the pre-load of the compression spring of the arrangement can take place.

It is also disclosed that the magnitude of the pre-load of the compression spring is in direct relation to the magnetic force built up by the magnet which overcomes the pre-load and holds the plunger in the setting position. The pre-load of the compression spring and the magnetic force built up by the magnet are in turn in direct relation to the quantity of energy required to activate the coil arrangement and counteract the magnetic force built up by the magnet. The pre-load of the compression spring can be calibrated or adjusted, and namely in such a way as to correspond to the quantity of energy available to activate the coil arrangement. This is particularly advantageous if there is a limited or set quantity of energy available for activating the coil arrangement.

By way of a calibration tool, a threaded screw or similar device for example is provided; this is connected to one side of the compression spring. In this way a setting of the pre-load of the compression spring can for example take place through turning of the screw.

Further mechanical adjustment solutions provide for a shifting of the permanent magnet out of the iron circuit or a turning of the permanent magnet in order, thereby, to set the required release energy.

From EP 0117250 A1, a method for the magnetic adjustment of holding magnetic release mechanisms is known in which the holding magnetic release mechanism is brought into a magnetic field. This magnetic field is turned until the magnetisation of the permanent magnet and hence the permanent flow via the release armature of the holding magnetic release mechanism is changed sufficiently that the release armature, at a pre-determined current through the activator winding, falls from the yoke body, i.e. the holding magnetic release mechanism releases.

In addition, a method and device for adjusting holding magnetic release mechanisms are known from EP 0307736 A1. It is disclosed that, in order to adjust the holding magnetic release mechanisms, the permanent magnet is set, in its field strength, at a target value. To this end this is first magnetised and subsequently demagnetised in a controlled manner. In accordance with the invention, for magnetisation an impulse with the same magnetic field direction is used and demagnetisation occurs using an impulse from an alternating magnetic field with decreasing amplitude. The holding magnet, if used in circuit breakers, is adjusted for several types of residual current.

A settable relay, consisting of a permanent magnet with poles connected through a gap-free shunt and one or two conductive coils on the pole ends and also an adjacent armature subject to spring force as a switching lifting device is known from DE 000002245151 A.

In order to set the permanent magnet, in its field strength, to a target value in order to achieve a certain responding current, it is provided that the permanent magnet initially magnetised to the maximum is demagnetised by being brought close to a current-carrying demagnetisation coil until the desired field strength, whereby the demagnetisation coil is activated by means of direct or alternating current and, as appropriate, step by step.

From DE 10 2009 030 479 B4, a magnetic release mechanism is known which comprises at least one yoke, having an armature opening, in which is placed an armature that is surrounded coaxially by at least one section of the coil body with at least one activator coil and can have the force of a pre-loaded spring element applied to it.

With this magnetic release mechanism the armature that has been pressed or moved in remains in a first end position when the activator coil has no current being supplied to it thanks to the magnetic holding force of the permanent magnet; in this end position associated external switching contacts, which are connected by means of suitable external mechanics to the magnetic release mechanism, are closed and a flow of current is enabled. By means of a short current pulse in the activator coil, the magnetic holding force of the permanent magnet is removed or at least weakened and the spring element designed as a compression spring moves the armature into its second end position, in which the associated switching contacts of the magnetic release mechanism are open and a flow of current is interrupted.

A disadvantage of the known prior art lies in the fact that, as a result of the high variation of the holding force of the magnetic release mechanism, even with low individual tolerances of the components, a narrow tolerance range is only achieved by a fraction of the magnetic release mechanisms produced.

Moreover, the known adjustment methods are complex and time-consuming and in part not sufficiently precise. Some adjustment methods also require an additional mechanical holding fixture for the permanent magnet or adjustment openings in the magnetic release mechanism housing. Both are undesirable, since mechanical assemblies are subject to wear and tear and openings in the magnetic release mechanism are an obstacle to the attempts to create a dustproof assembly. In addition, some adjustment methods are not suitable for adjustment on a ready-mounted or assembled magnetic release mechanism.

### SUMMARY OF THE INVENTION

Thus, there is a desire for a method for adjusting the magnetic release mechanism.

It is provided that the method for adjusting a magnetic release mechanism is performed in at least one, as appropriate in several, adjustment steps. At the beginning of the method, measurement of the present release current I of the magnetic release mechanism takes place. To this end, a continually increasing current is generated using a control unit and supplied to the coil of the magnetic release mechanism. This increasing current leads to a magnetic field generated by the coil and increasing in strength, which counteracts the magnetic field of the permanent magnet, which holds the armature in the first end position. If the magnetic field generated by the coil is strong enough and hence the magnetic field of the permanent magnet sufficiently weakened, then the magnetic release mechanism releases and the armature moves, driven by a spring, from the first end position into the second end position.

Preferably, this movement is detected and the present release current I stored at this point in time. Provision is made to evaluate this release current I and, depending on the result of this evaluation, to make a decision on how the method is to progress.

Preferably, if it is established during the evaluation that the release current I lies within a specified tolerance range, then adjustment of the magnetic release mechanism is not necessary and the procedure is terminated.

Preferably, if, however, it is established that the release current I does not lie within the tolerance range, at least one adjustment step is carried out. To this end, an adjustment current I_{J} dependent on the release current I is determined and used for the partial demagnetisation of the permanent magnet in the magnetic release mechanism. Such a determination of the adjustment current I_{J} can for example be performed using a table which contains an allocation of a release current I to an adjustment current I_{J} that is to be selected in the method. Here provision may also be made to allocate a certain range of the release current I to a single value of the adjustment current I_{J}.

Preferably, with the determined adjustment current I_{J}, the partial demagnetisation of the permanent magnet of the magnetic release mechanism is controlled. Subsequently the armature of the magnetic release mechanism is brought from the second end position into the first end position and the method continued with a measurement of the new present release current I of the magnetic release mechanism in a first step of the method.

Preferably, in turn, an evaluation of the new present release current I is performed. The method is continued until the release current I lies within the tolerance range.

Preferably, it is provided that the point (in time) of release of the magnetic release mechanism is recorded using a detection tool. For this purpose a contact or detection tool that works in a no-contact manner, for example a light barrier, can be used. The use of a detection tool that works capacitively is also possible. The signal from the detection tool is for example fed to a central control unit which records the present release current I and stores it for the subsequent course of the method. A light barrier may for example be arranged in such a way that it enables detection of the end position of the armature.

Preferably, it is provided that the range of the release current I, outside of the tolerance range within which adjustment is possible, is for example divided into four subranges. An adjustment current I_{J} is allocated to each subrange so that the first adjustment current I_{J1} is allocated to the first subrange, the second adjustment current I_{J2} is allocated to the second subrange, etc.

Preferably, if for example a release current I is measured whose value lies in the second subrange, then the associated second adjustment I_{J2} is selected and during the subsequent adjustment step used for partial demagnetisation of the permanent magnet. It is provided that the adjustment current I_{J4} has the smallest and the adjustment current I_{J1} has the largest value. (I_{J4}<I_{J3}<I_{J2}<I_{J1})

Preferably, in an alternative design, provision is made to subdivide one or more of the—for example—four subranges into further sub-subranges, whereby a separate adjustment current I_{J} is allocated to each of these sub-subranges.

Preferably, the determination of an advantageous relationship between a measured release current I and an adjustment current I_{J} to be used for adjustment may for example occur by empirical methods, whereby the results are recorded in a table which is available to the method for evaluation or selection of the adjustment current I_{J}.

Preferably, it is particularly advantageous that before each measurement of the release current I a re-setting of the armature of the magnetic release mechanism from the second end position into the first end position occurs by means of a re-setting unit. This re-setting unit can be designed as a pneumatically driven cylinder. In an alternative, a linear motor or a unit working in a similar way and providing linear motion is used. In this way it is also possible for example for a rotary motion of an electric motor to be converted by means of suitable gearing into a linear motion which is suitable for pressing the armature into the magnetic release mechanism.

Preferably, in a particular design of the invention, provision is made to decide after the first measurement of the release current I whether or not an adjustment step is necessary. In the event that an adjustment step has to be performed, as the release current I does not lie in the specified tolerance range between I_{TARGET}_{_}ₘᵢₙ and I_{TARGET}_{_}ₘₐₓ, a first ‘start-adjustment current’ is selected which has a value defined before the start of the method. By means of this start-adjustment current, the first adjustment step for the partial demagnetisation of the permanent magnet is performed.

Preferably, if, during a subsequent measurement of the release current I, it is established that I lies in the specified tolerance range between I_{TARGET}_{_}ₘᵢₙ and I_{TARGET}_{_}ₘₐₓ, then the method for adjusting a magnetic release mechanism is terminated.

Preferably, if the release current I does not lie in the specified tolerance range, the ‘start-adjustment current’ is increased by a first differential amount ΔI_{Jn} and a further adjustment step is performed with this increased adjustment current.

Preferably, if, during a further subsequent measurement of the release current I, it is established that I lies in the specified tolerance range between I_{TARGET}_{_}ₘᵢₙ and I_{TARGET}_{_}ₘₐₓ, then the method for adjusting a magnetic release mechanism is terminated.

Preferably, if the release current I does not lie in the specified tolerance range, the most recently used adjustment current, formed from the start-adjustment current and the first differential amount ΔI_{Jn}, is increased further and a second differential amount ΔI_{Jn} added to it. For the subsequent adjustment step the new, larger adjustment current formed from the start-adjustment current, the first differential amount ΔI_{Jn} and the second differential amount ΔI_{Jn} is used. This type of increase to the previously used adjustment current is continued for as long as the release current I lies within the tolerance range.

Preferably, here it may be provided that the differential amounts ΔI_{Jn} are equally large. In a more advantageous embodiment it is provided that differential amounts ΔI_{Jn} of different magnitudes are used, whereby the choice of magnitude of the different differential amounts depends on how far the release current I is from the specified target value I_{TARGET}.

Preferably, if it is established that the difference from the target value is large, then a large differential amount ΔI_{Jn} is selected. In the event that the difference from the target value is smaller, then a smaller differential amount ΔI_{Jn} is selected. In the event that the difference from the target value is the smallest, then the smallest differential amount ΔI_{Jn} is selected.

Preferably, in this way, it is possible to systematically bring the release current I close to the specified target value I_{TARGET}, whereby, at the same time one avoids the value falling below—which would be undesirable—a lower tolerance limit I_{TARGET}_{_}ₘᵢₙ through the use of an adjustment current that is too large.

Preferably, in one design example, four differential amounts ΔI_{Jn} of different magnitudes (ΔI_{J1}, ΔI_{J2}, ΔI_{J3}, ΔI_{J4}) are used in the method.

Preferably, in a further particular design it is envisaged that the relationships are selected in such a way that ΔI_{J4} is twice as big as ΔI_{J3}, ΔI_{J3} is twice as big as ΔI_{J2} and ΔI_{J2} is twice as big as ΔI_{J1}.

In the method of adjusting the magnetic release mechanism of embodiments of the present invention, the required release current is reduced and lies within a specified tolerance range, whereby as a result of the lower current limit shockproofness is maintained and the time and costs for adjusting the magnetic release mechanism are reduced.

### BRIEF DESCRIPTION OF THE DRAWINGS

FIG. 1 is a schematic diagram of a magnetic release mechanism in accordance with the prior art.

FIG. 2 is a diagram with a frequency distribution of releasing magnet release mechanisms based on the release current of the magnetic release mechanism.

FIG. 3 is an arrangement for implementing the adjustment method according to the invention.

FIG. 4 is diagram of several characteristic curves of demagnetisation for magnet release mechanisms.

FIG. 5 is an initial flow chart of the method according to the invention.

FIG. 6 is a second alternative flow chart of the method according to the invention.

FIG. 7 is a graphical representation of the method using the flow chart in accordance with FIG. 6.

### DETAILED DESCRIPTION OF THE PREFERRED EMBODIMENTS

The technical solutions of the embodiments of the present invention will be clearly and completely described as follows with reference to the accompanying drawings. Apparently, the embodiments as described below are merely part of, rather than all, embodiments of the present invention. Based on the embodiments of the present invention, any other embodiment obtained by a person skilled in the art without paying any creative effort shall fall within the protection scope of the present invention.

It is noted that, when a component is described to be “fixed” to another component, it can be directly fixed to the another component or there may be an intermediate component. When a component is described to be “connected” to another component, it can be directly connected to the another component or there may be an intermediate component. When a component is described to be “disposed” on another component, it can be directly disposed on the another component or there may be an intermediate component.

Unless otherwise specified, all technical and scientific terms have the ordinary meaning as commonly understood by people skilled in the art. The terms used in this disclosure are illustrative rather than limiting. The term “and/or” used in this disclosure means that each and every combination of one or more associated items listed are included.

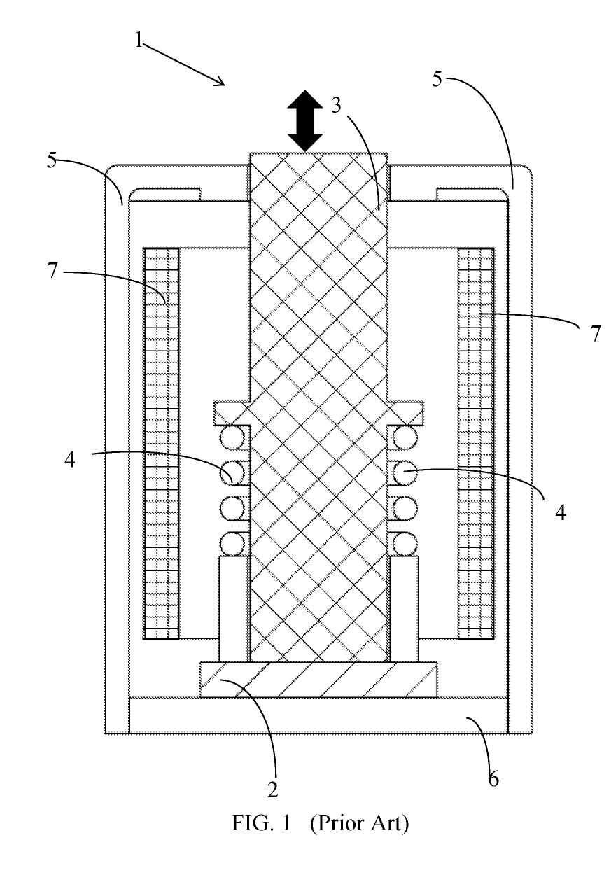

FIG. 1 shows a schematic diagram of a magnetic release mechanism 1 in accordance with the prior art. The magnetic release mechanism 1 comprises a permanent magnet 2, above which an armature 3 is shown positioned in an end position. In this first end position the contacts of the magnetic release mechanism 1, which are mechanically connected to the armature and not shown in FIG. 1, are closed. Via these contacts, in the first end position an outer circuit can be closed.

The magnetic release mechanism 1 is surrounded by a housing 5 and a base plate 6 which are manufactured from a material that enables a magnetic flow. Thus the ‘iron circuit’, i.e. a closed circuit for the magnetic flow, can be formed via the permanent magnet 2, the armature 3, the housing 5 and the base plate 6.

If, in the coil 7 arranged in the magnetic release mechanism 1 around the permanent magnet 2 and the armature 3, a current of sufficient magnitude flows, then through the coil 7 a magnetic field is generated which weakens the magnetic field of the permanent magnet 2. If this weakening is sufficiently large, the armature 3 is moved via the spring 4 into its second end position. In this second end position, in which a part of the armature 3 protrudes significantly out of the housing 5, the associated switching contacts are opened and the outer circuit is therefore interrupted.

If the circumstance that has caused the current through the coil 7, for example a short circuit, has been eliminated, then the armature 3 can be pressed into the magnetic release mechanism 1 and hence from its second end position back into the first end position, whereby the switching contacts close. In this end position the armature 3 is held through the effect of the magnetic field of the permanent magnet 2.

In this design the required release energy of the magnetic release mechanism 1 or the current necessary for the coil 7 is dependent on the field strength of the magnetic field of the permanent magnet 2. Since this field strength of the permanent magnet 2 has strong variation for production-related reasons, only a limited reduction in the field strength of the permanent magnet 2 is possible during production as it must be ensured that permanent magnets 2, produced with a minimal field strength, also generate a magnetic field which is strong enough to hold the armature 3 securely in the first end position. In addition, the production tolerances of the magnetic release mechanism 1 as a whole, in particular different surface qualities, coating thicknesses, residual air gap or spring characteristics of the different individual parts of the magnetic release mechanism 1, bring about an additional variation of the release current.

The permanent magnets 2 required for the magnetic release mechanisms 1 are produced in such a way that they have, on average, a magnetic field that is too strong. In particular, it is important that the permanent magnets 2 are produced in such a way that their release current I, after the production of the magnetic release mechanism 1, is not less than I_{TARGET}_{_}ₘᵢₙ. The invention provides that all magnetic release mechanisms which have a release current I greater than I_{TARGET}_{_}ₘₐₓ undergo one or more adjustment steps, during which a targeted weakening of the magnetic field of the corresponding permanent magnet 2 is induced.

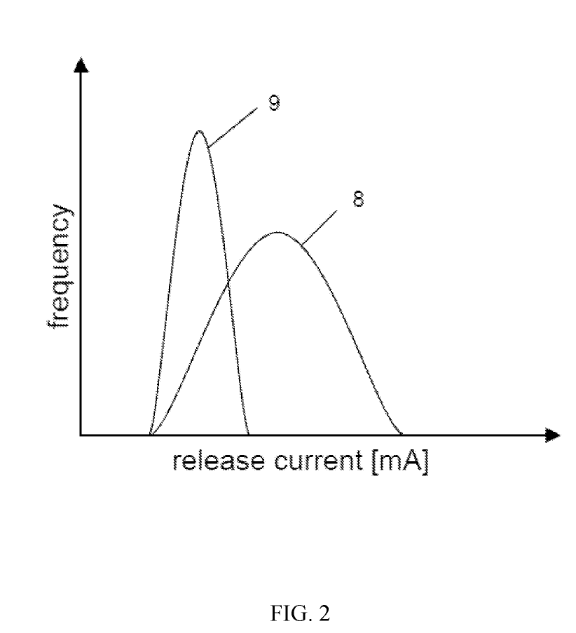

FIG. 2 shows a frequency of the release of the magnetic release mechanism 1 as a function of the release current I. Here the first curve 8 describes a distribution of the release current I for non-adjusted magnetic release mechanisms 1 coming out of production. One can discern a broad scattering, over a large range, of the release current I.

If these magnetic release mechanisms 1, as proposed in this Description, are adjusted accordingly, one can clearly discern in curve 9 that the range of the release current I, in which the magnetic release mechanisms 1 release, can be made significantly narrower. Over and above this, the range of the release current I lies in the lower range of the release current I of the first curve 8. Hence it was possible to uniformly reduce the required release energy or the required release current I for the release of the magnetic release mechanism 1.

Provision is made to adjust the permanent magnet 2, which is located in a ready-mounted magnetic release mechanism 1, through targeted demagnetisation. To this end, the assembled magnetic release mechanism 1 is secured in an adjustment arrangement 10 on an adjustment site 11.

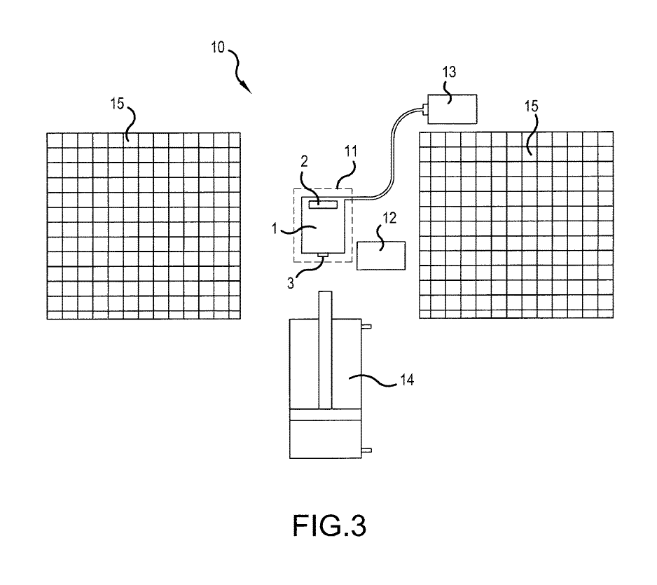

In order to detect the release of the magnetic release mechanism 1, during which the armature 3 moves from its first end position into its second end position, a detection tool is provided. This detection tool may for example be a mechanical contact or, as shown in FIG. 3, a light barrier 12. This light barrier 12 is arranged in such a way that it can reliably record the position of the armature 3 in both end positions.

The magnetic release mechanism 1 is connected via an appropriate line to a control unit 13, which can generate a release current I that for example is increasing. In order to be able to bring the armature 3, after a release of the magnetic release mechanism 1, from its second end position back into its first end position, and hence to enable a further measurement of the release current I, a re-setting unit 14 is arranged in the adjustment arrangement 10. This re-setting unit 14 can be designed as a pneumatically driven cylinder, a linear motor or a unit working in a similar way and providing a linear motion. FIG. 3 shows a design with a pneumatically driven cylinder.

The adjustment arrangement 10 additionally has an adjustment coil 15 which for example surrounds the adjustment site 11 on which the magnetic release mechanism 1 is located during an adjustment process. In FIG. 3 the adjustment coil 15 is shown only schematically in a cross-sectional view. The assemblies of the adjustment arrangement 10 are connected to a central control unit (not shown) which controls the entire procedure during the testing of the magnetic release mechanisms 1 and their adjustment.

In the text below, an example of an adjustment process is described. At the beginning of an adjustment process the magnetic release mechanism 1 is positioned on an adjustment site 11 which is surrounded by an adjustment coil 15. The parameter to be adjusted is the release current I of the magnetic release mechanism 1. For this reason, using the control unit 13, a continuously increasing release current I is generated for the coil 7 of the magnetic release mechanism 1 in an initial measurement process. This generation of the release current I is continued by the control unit 13 until the magnetic release mechanism 1 releases and the armature 3 moves from the first end position into the second end position. This change in the position of the armature 3 is detected using the light barrier 12, a signal is generated for the central control unit and the present release current I, under which the release has occurred, is stored.

Depending on the release current I determined, a decision is taken by means of a comparison with a specified release current I_{TARGET} as to whether or not an adjustment of the magnetic release mechanism 1 is necessary.

If the release current I has precisely the value of the specified release current I_{TARGET} or if the release current I lies within a specified tolerance range between a current I_{TARGET}_{_}ₘᵢₙ and a current I_{TARGET}_{_}ₘₐₓ, then no further adjustment process must be performed.

In the event that the release current I is smaller than the minimum permitted current I_{TARGET}_{_}ₘᵢₙ, the magnetic release mechanism 1 is rejected, as it does not reach the required parameters and releases too soon. An adjustment of such magnetic release mechanisms 1 is not provided for according to the method. For this, the adjustment arrangement would have to be extended for example by a further adjustment coil known from the prior art, by means of which a magnetisation of the permanent magnets 2 can be performed. After this magnetisation the method according to the invention can be deployed.

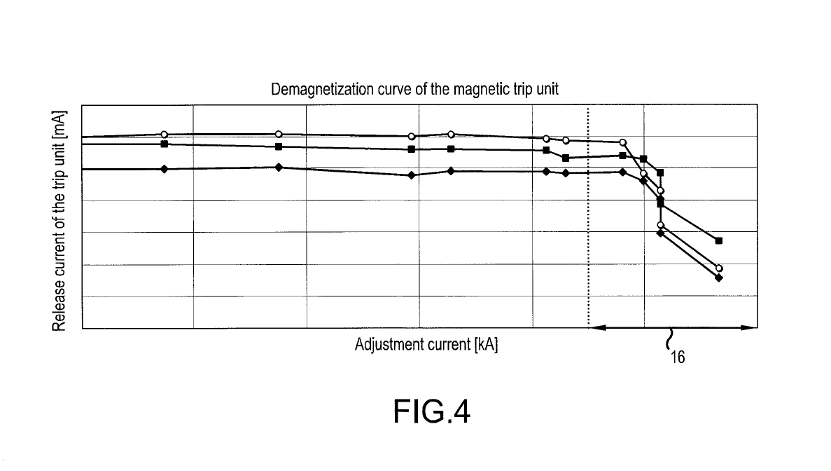

In the event that the release current I lies in a range greater than I_{TARGET}_{_}ₘₐₓ, at least one adjustment process takes place, which may comprise several adjustment steps. In a first step, a first adjustment current I_{J} is selected. This first adjustment current I_{J} may be selected only so large that the permanent magnet 2 of the magnetic release mechanism 1 is not too greatly weakened, so that the value does not fall below the lower current threshold I_{TARGET}_{_}ₘᵢₙ. The adjustment process takes place in the region of what is known as a ‘kink’ in the curve, as for example is shown in FIG. 4 for various magnetic release mechanisms 1. To this end, reference can also be made to the well-known B-H curve of neodymium magnets.

By means of this adjustment current I a magnetic field is generated in the adjustment coil 15 for the partial demagnetisation of the permanent magnet 2. When this first adjustment step is completed, the armature 3 is, by means of the re-setting device 14, brought back into its first end position, in which it is held through the magnetic field of the permanent magnet 2.

Subsequently, in a second measurement process, once again a continuously increasing release current I is generated for the coil 7 of the magnetic release mechanism 1 through the control unit 13 and the process of release detected by means of the light barrier 12. In this case, too, the present release current I is determined and stored. After this second measurement process, once again a comparison is made of the present release current I measured with the specified release current I_{TARGET} or the tolerance range between I_{TARGET}_{_}ₘᵢₙ and I_{TARGET}_{_}ₘₐₓ. Depending on this comparison, it is in turn decided whether or not a second or further adjustment step with a second or further adjustment current I_{J} is to be performed.

If a second or further adjustment step is necessary, this is performed with an adjustment current I_{J} that is larger in comparison with the previous adjustment step. The absolute value of the adjustment current I_{J} and hence also the difference from the previously set adjustment current I_{J} can be made dependent on how large the difference is between the measured release current I and the specified release current I_{TARGET}. Thus for example, in the event that there is still a relatively large difference between the release current I and the specified release current I_{TARGET}, the difference from the previously selected adjustment current I_{J} can be selected larger than in the event that release current I is relatively close to the specified release current I_{TARGET}.

Alternatively, each adjustment step can also be performed with an equal difference from the adjustment current I_{J}, based on the previously set adjustment current I_{J}.

It is also provided that the difference between the adjustment currents I_{J} to be set becomes smaller with an increasing number of adjustment steps, in order to avoid the value falling below the minimum current value I_{TARGET}_{_}ₘᵢₙ.

In order to design simple and effective selection of the adjustment current I_{J} a table may for example be stored in the central control unit which is used to select the adjustment current I_{J} as a function of the determined release current I.

Using the adjustment current I_{J} selected in the second or further adjustment step, a magnetic field is in turn generated in the adjustment coil 15 for the partial demagnetisation of the permanent magnet 2. If this second or further adjustment step is completed, then by means of the re-setting device 14 the armature 3 is brought back into its first end position, in which it is held by means of the magnetic field of the permanent magnet 2.

Subsequently, in a further measurement process, the present release current I is determined and, in turn, stored. This procedure—described above—with the comparison of the measured release current I with the specified release current I_{TARGET} and with a possible further adjustment step is continued until the release current lies at least within the tolerance range between I_{TARGET}_{_}ₘᵢₙ and I_{TARGET}_{_}ₘₐₓ.

When this state has been achieved, then the release current I is, in accordance with the method, set at a reduced value and hence a reduction in the required release energy is achieved.

FIG. 4 shows, in a diagram, the relationship between an adjustment current I_{J} used during a demagnetisation process and the release current I set by means of this adjustment process for three different magnetic release mechanisms 1.

Marked on the characteristic curves are measurement points using the symbols circle, square and diamond. Thus it can be discerned, for example, that when setting an adjustment current I_{J} which lies outside of the region 16, the release current required to release the magnetic release mechanism 1 barely changes. Thus an effective adjustment of the release current I and of the required release energy is not achieved until region 16, in which there is high sensitivity for the adjustment and in which the characteristic curves display a clear kink. These kinks in the characteristic curves of the three permanent magnets 2 of the three magnetic release mechanisms 1 are caused by the B-H curve, which also has a kink in the characteristic curve, which describes the magnetic flow density B as a function of the impact of an external magnetic field H on the permanent magnet 2. In one embodiment, the permanent magnet 2 is a neodymium magnet.

Knowing this characteristic curve pattern it is for example possible, outside of the region 16, to choose a greater increment for the selection of the adjustment current I_{J}, while within the region 16 adjustment must take place with appropriately small increments when selecting the adjustment current I_{J} in order not to set a release current I that is smaller than I_{TARGET}_{_}ₘᵢₙ.

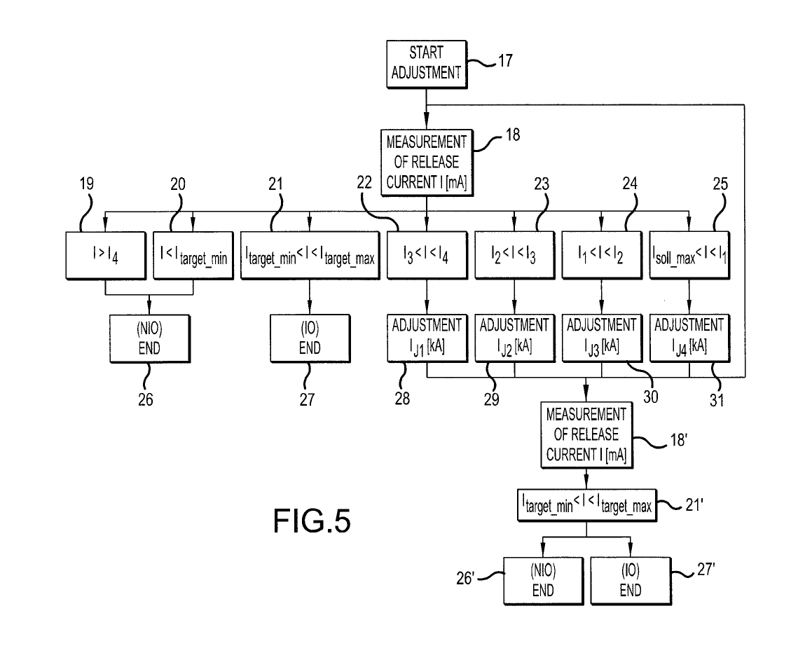

FIG. 5 shows, by way of an example, a flow chart of the method according to the invention for the adjustment of a magnetic release mechanism 1. After the start of the adjustment method in Step 17, in Step 18 a measurement is performed of the release current I, as described above in the adjustment arrangement 10.

Subsequently a comparison is made of the present release current I measured with the specified release current I_{TARGET}. This comparison is performed in the example of FIG. 5 in such a way that the regions 19 to 25 are made available and a check is made as to in which of these regions 19 to 25 the present release current I measured lies.

If the measured release current I lies in the first region 19, i.e. is larger than the release current I₄, then the release current I lies above a threshold permitted in the method. In this case, no adjustment is performed and the magnetic release mechanism 1 is rejected in Step 26. The method hence ends in Step 26 without having provided a successfully adjusted magnetic release mechanism 1.

If the present release current I measured lies in the second region 20 below a fixed minimum release current I_{TARGET}_{_}ₘᵢₙ, provision is made to likewise reject the magnetic release mechanism 1 in Step 26, since this magnetic release mechanism 1 releases too soon, i.e. at a current below I_{TARGET}_{_}ₘᵢₙ. In this case the method ends in Step 26.

If the measured release current I lies in the third region 21, i.e. is larger than the minimum permitted release current I_{TARGET}_{_}ₘᵢₙ and smaller than the maximum permitted release current I_{TARGET}_{_}ₘₐₓ, then it lies within the fixed tolerance range and an adjustment is hence not, or no longer, necessary.

If the present release current I measured lies in the fourth region 22, in the fifth region 23, in the sixth region 24 or in the seventh region 25, a corresponding adjustment current I_{J} is selected and an adjustment step performed with this.

If the release current I is classified in the fourth region 22, in Step 28 a first adjustment current I_{J1} is selected and, with this, the adjustment step for the demagnetisation of the permanent magnet 2 performed. If the release current I lies in the fifth region 23, then in Step 29 the second adjustment current I_{J2} is selected. Accordingly, with a release current I in the sixth region 24, the third adjustment current I_{J3} is selected in Step 30 and for a release current I in the seventh region 25 the fourth adjustment current I_{J4} is selected in Step 31 and used in the subsequent adjustment step in each case. Here it is provided that the adjustment current I_{J1} is the largest and the adjustment current I_{J4} by comparison the smallest adjustment current (I_{J4}<I_{J3}<I_{J1}<I_{J2}), in a magnitude of a few kiloamps (kA).

With one example of an adjustment process, an increasing release current I is generated using the control unit 13 and it is detected when the magnetic release mechanism 1 releases and the armature 3 moves from its first into the second end position. The release of the magnetic release mechanism 1 is detected by the light barrier 12 and the present release current I recorded or stored. With this first measurement process it is assumed that a release current I is measured which lies between the currents I₃ and I₄ i.e. in the fourth region 22. Hence the adjustment current I_{J1} is selected in Step 28 and by means of this selected current I_{J1} the adjustment step for partial demagnetisation of the permanent magnet 2 performed. With this adjustment step a magnetic field that is opposed to the magnetic field of permanent magnet 2 is built up, at least temporarily, by means of adjustment coil 15, which has current I_{J1} flowing through it in pulses.

If, in the first measurement process, a present release current I is for example determined which for instance is greater than I₁ but less than I₂ and hence lies in the sixth region 24, then in Step 30 the adjustment current I_{J3}, which is smaller than the adjustment current I_{J1}, is used for demagnetisation in the adjustment step.

If a release current I is measured which lies above I_{TARGET}_{_}ₘₐₓ and below I₁ and hence can be allocated to the seventh region 25, then in Step 31 the adjustment current I_{J4} is selected which is smaller than the adjustment current I_{J3}.

If the adjustment performed results in the setting of a release current I for the magnetic release mechanism 1 which lies in the tolerance range 21′ between I_{TARGET}_{_}ₘᵢₙ and I_{TARGET}_{_}ₘₐₓ and is measured in Step 18′, the adjustment step has been performed successfully. In this case the adjustment process is terminated in Step 27′ and the magnetic release mechanism 1 can be removed from the adjustment site 11 of the adjustment arrangement 10.

If the specified tolerance range is not achieved, then the procedure ends unsuccessfully in Step 26.

A demagnetisation of the permanent magnet 2 by means of an adjustment current I_{J1} to I_{J4} selected according to the method can for example be performed in such a way that a charging of a capacitor occurs such that the latter, on its discharging via the coil 7, and also an ohmic element, generates a current pulse with one of the desired adjustment current intensities I_{J1} to I_{J4}, whereby the pulse subsides in accordance with a normal discharge curve.

This current pulse generates, in the coil 7, a magnetic field, which is aligned opposed to the magnetic field of the permanent magnet 2 and is suitable for at least partially demagnetising the permanent magnet 2. For this purpose the magnetic field generated must have a corresponding field strength, which is dependent on the selected adjustment current I_{J1} to I_{J4}.

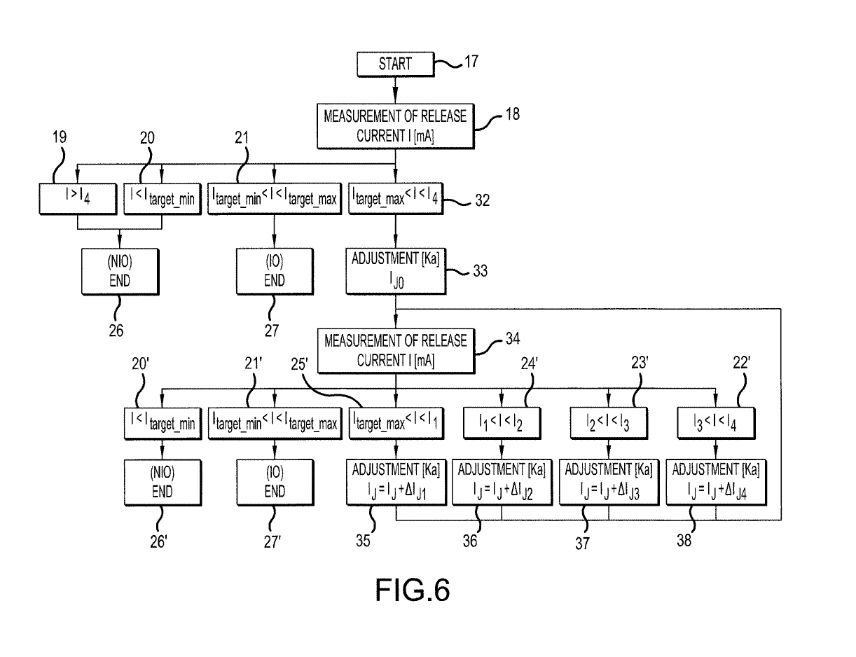

FIG. 6 shows a second alternative flow chart of the method according to the invention. Whilst the method in accordance with FIG. 5 requires precise specification of the adjustment currents I_{J1} to I_{J4} to be selected in order to adjust, in one adjustment step, the specified tolerance range for the release current I, the method in accordance with FIG. 6 works with at least one, mostly several adjustment steps in which the adjustment current I_{J} is set step-by-step to the required intensity. The advantage of this method alternative lies in a high level of reliability in the adjustment of the magnetic release mechanism 1.

The procedure corresponds at least partially to the procedure described for FIG. 5. For example, after the start of the adjustment process, in Step 17, in Step 18 an initial measurement of the release current I is performed in the adjustment arrangement 10.

Subsequently a comparison is made of the present release current I measured with the specified release current I_{TARGET}.

If the measured release current I lies in the first region 19, i.e. is larger than the release current I₄, then the release current I lies above a threshold permitted in the method. In this case no adjustment is performed and the magnetic release mechanism 1 is rejected in Step 26. The method therefore ends in Step 26.

If the present release current I measured lies in the second region 20 below a fixed minimum release current I_{TARGET}_{_}ₘᵢₙ, provision is made to likewise reject the magnetic release mechanism 1 in Step 26, since this magnetic release mechanism also releases too soon, i.e. at a current below I_{TARGET}_{_}ₘᵢₙ. In this case the method ends in Step 26.

If the measured release current I lies in the third region 21, i.e. is larger than the minimum permitted release current I_{TARGET}_{_}ₘᵢₙ and smaller than the maximum permitted release current I_{TARGET}_{_}ₘₐₓ, then it lies within the fixed tolerance range and an adjustment is therefore not or no longer necessary. The method ends in Step 27.

If the present release current I measured lies in an eighth region 32, i.e. in a region larger than I_{TARGET}_{_}ₘᵢₙ and smaller than I₄, then in Step 33 an adjustment current I_{J0} is selected as a ‘start-adjustment current’, and with this adjustment current I_{J0} the first adjustment step is performed. The fixing of this start-adjustment current takes place, for example, empirically, whereby the value is stored in a memory and is available to the method at any time.

In the event that another type or another series of magnetic release mechanisms 1 are adjusted, then value for the start-adjustment current can be changed and hence adapted to the relevant type.

After the implementation of the first adjustment step with the fifth adjustment current I_{J0} selected in Step 33, the armature 3 of the magnetic release mechanism 1 is brought by means of the re-setting unit 14 into the first end position and in Step 34 a second measurement of the release current I is performed.

The value measured at that particular time for the release current I is subsequently classified in one of the regions shown: 20′, 21′, 22′, 23′, 24′ or 25′. If classified in region 20′, then the first adjustment step has demagnetised the permanent magnet too strongly or weakened it, so that the release current I no longer reaches a minimum value of I_{TARGET}_{_}ₘᵢₙ. The method hence ends in Step 26′.

If the present release current I measured lies in region 21′, i.e. is bigger than the minimum permitted release current I_{TARGET}_{_}ₘᵢₙ and smaller than the maximum permitted release current I_{TARGET}_{_}ₘₐₓ, then it lies within the fixed tolerance range for the release current I and an adjustment is therefore no longer necessary. In this case, the method ends in Step 2T.

If the first adjustment step, using the adjustment current I_{J0}, has not yet sufficiently demagnetised the permanent magnet, then the release current I measureable after to this adjustment step still lies in a region above the current I_{TARGET}_{_}ₘₐₓ. According to the method, at least one further adjustment step must be carried out. The magnitude of the adjustment current I_{J} to be used for a next adjustment step is dependent on the difference between the specified release current I_{TARGET} and the present release current I measured.

To this end 4 current values or current indicators I1, I2, I3 and I4 for example are fixed, whereby I1<I2<I3<I4 and all current indicators I1, I2, I₃ and I₄ lie above the release current I_{TARGET}_{_}ₘₐₓ.

In the event that the release current I measured in Step 34 lies in a range between I_{TARGET}_{_}ₘₐₓ and I₁ in Step 25′, then in Step 35 a sixth adjustment current I_{J} is selected. This sixth adjustment current I_{J} is formed in such a way that a first proportion ΔI_{J1} is added on to the fifth adjustment current I_{J0} selected in Step 33. This results in an adjustment current I_{J} selected in Step 35 in accordance with I_{J}=I_{J}+ΔI_{J1}. This sixth adjustment current I_{J}, which is greater by the amount ΔI_{J1}, is used in the subsequent second adjustment step for the partial demagnetisation of the permanent magnet 2.

In the event that the release current I measured in Step 34 lies in a region 24′ between I₁ and I₂, then in Step 36 a seventh adjustment current I_{J} is selected. This seventh adjustment current I_{J} is formed by a second proportion ΔI_{J2} being added to the fifth adjustment current I_{J0} selected in Step 33. This second proportion ΔI_{J2} is larger than the first proportion ΔI_{J1}. In a particular case ΔI_{J2} is twice as large as ΔI_{J1}. This results in a seventh adjustment current I_{J} selected in Step 36 in accordance with I_{J}=I_{J}+ΔI_{J2}. This seventh adjustment current I_{J} which is greater by the amount ΔI_{J2} is used in the subsequent adjustment step for the partial demagnetisation of the permanent magnet 2.

In the event that the release current I measured in Step 34 lies in a region 23′ between I₂ and I₃, then in Step 37 an eighth adjustment current I_{J} is selected. This eighth adjustment current I_{J} is formed by a third proportion ΔI_{J3} being added to the fifth adjustment current I_{J0} selected in Step 33. This third proportion ΔI_{J3} is greater than the second proportion ΔI_{J2}. In a particular case ΔI_{J3} is twice as large as ΔI_{J2}. This results in an eighth adjustment current I_{J} selected in Step 37 in accordance with I_{J}=I_{J}+ΔI_{J3}. This eighth adjustment current I_{J} which is greater by the amount ΔI_{J3} is used in the subsequent adjustment step for the partial demagnetisation of the permanent magnet 2.

In the event that the release current I measured in Step 34 I lies in a region 22′ between I₃ and I₄, then in Step 38 a ninth adjustment current I_{J} is selected. This ninth adjustment current I_{J} is formed by a fourth proportion ΔI_{J4} being added to the fifth adjustment current selected in Step 33. This fourth proportion ΔI_{J4} is larger than the third proportion ΔI_{J3}. In a particular case ΔI_{J4} is twice as large as ΔI_{J3}. This results in a ninth adjustment current I_{J} selected in Step 38 in accordance with I_{J}=I_{J}+ΔI_{J4}. This ninth adjustment current I_{J} which is greater by the amount ΔI_{J4} is used in the subsequent second adjustment step for the partial demagnetisation of the permanent magnet 2.

Using one of the adjustment currents selected in the Steps 35, 36, 37 or 38, the subsequent adjustment step is performed and a further demagnetisation of the permanent magnet 2 induced. Following this adjustment step the armature 3 of the magnetic release mechanism 1 is moved using the re-setting unit 14 into the first end position and the procedure continued in Step 34 with a further measurement of the present release current I.

In a second run-through of the lower loop in the procedure beginning with the measurement of the release current I in Step 34, the fifth adjustment current I_{J0} selected in Step 33 is no longer the basis for the calculation of a further adjustment current in Steps 35, 36, 37 and 38. In a second and further run-through, the new adjustment current I_{J} in Steps 35, 36, 37 and 38 is always formed by the adjustment current I_{J} used in the preceding adjustment step being further increased by a corresponding differential amount ΔI_{J1} or ΔI_{J2} or ΔI_{J3} or ΔI_{J4}. For example, in a first adjustment step adjustment takes place with an adjustment current I_{J}=I_{J0}, in a second adjustment step with the adjustment current I_{J}=I_{J0}+ΔI_{J4} and in a third adjustment step with an adjustment current I_{J}=I_{J0}+ΔI_{J4}+ΔI_{J2}.

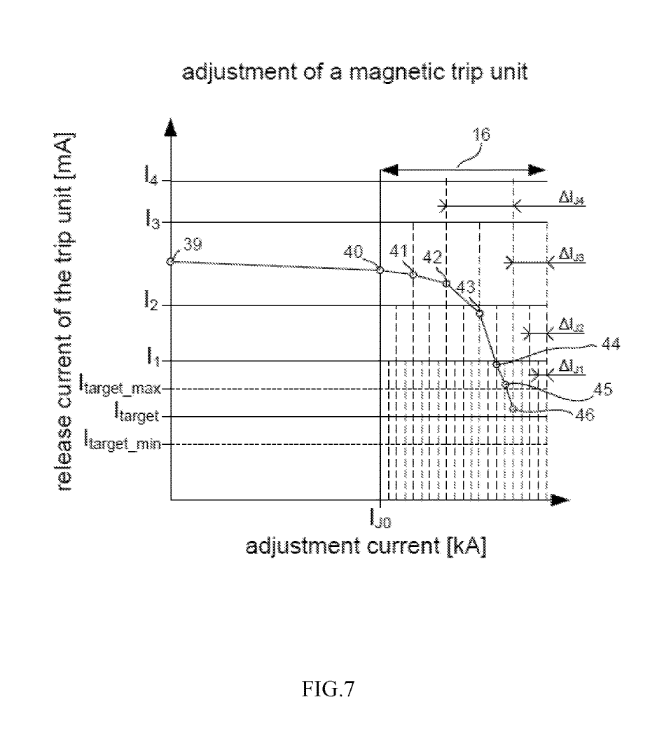

FIG. 7 shows a graphical representation of the method using the flow chart in accordance with FIG. 6. The diagram illustrates the release current I of the magnetic release mechanism 1 in the unit milliamps above an adjustment current I_{J0} in kiloamps.

In the text below, the invention is described using a further embodiment with the aid of FIG. 7. The release current I of the magnetic release mechanism 1, with a first measurement in Step 18 before adjustment, lies in the region between I₂ and I₃, hence in the area of the eighth region 32, and in Step 33 the fifth adjustment current I_{J0} is selected for the first adjustment step. This first measured value 39 is shown by means of a circle on the y-axis at the beginning of the curve drawn. Adjustment takes place during which the fifth adjustment current I_{J}=I_{J0} is used.

After a re-setting of the magnetic release mechanism 1, in Step 34 a second measurement takes place in order to establish whether the release current I now lies in the specified tolerance range between I_{TARGET}_{_}ₘᵢₙ and I_{TARGET}_{_}ₘₐₓ. With this measurement, a release current I is determined which still lies in the region 25′ between I₂ and I₃ and is displayed as measured value 40. Since the release current I lies in the region 23′, in Step 37 a differential amount ΔI_{J3} is determined and added to the previously used adjustment current I_{J}. Thus for the second adjustment step an adjustment current in accordance with I_{J}=I_{J0}+ΔI_{J3} is formed and the second adjustment step performed.

After a renewed re-setting of the magnetic release mechanism 1, in Step 34 a third measurement occurs in order to establish, once again, whether the release current I now lies in the specified tolerance range between I_{TARGET}_{_}ₘᵢₙ and I_{TARGET}_{_}ₘₐₓ. With this third measurement a release current I is established which still lies in the region 23′ between I₂ and I₃ and is displayed as measured value 41 in FIG. 7. Since the release current I lies in the region 23′, in Step 37 a differential amount ΔI_{J3} is once again determined and once again added to the previously used adjustment current I_{J}. Thus for the third adjustment step an adjustment current in accordance with I_{J}=I_{J0}+ΔI_{J3}+ΔI_{J3} is formed and the second adjustment step performed.

With the subsequent fourth measurement, too, it is established that the release current I, displayed in measured value 42, still lies in the region 23′ between I₂ and I₃, even if, in terms of its value, it has reduced somewhat after each adjustment step. Thus for the subsequent fourth adjustment step an adjustment current in accordance with I_{J}=I_{J0}+ΔI_{J3}+ΔI_{J3}+ΔI_{J3} is formed and the fourth adjustment step performed.

After this fourth adjustment step the release current I determined in a fifth measurement in Step 34 lies in the region 24′ between I₁ and I₂, displayed as measured value 43 in FIG. 7. Therefore with classification into region 24′ a selection of a differential amount ΔI_{J2} is performed in the associated Step 36 which must be added to the previously used adjustment current. Thus for the subsequent fifth adjustment step an adjustment current in accordance with I_{J}=I_{J0}+ΔI_{J3}+ΔI_{J3}+ΔI_{J3}+ΔI_{J2} is formed and the fifth adjustment step performed.

As a result of this adjustment step, in the sixth measurement in Step 34 a release current I is determined in the region 25′ between I_{TARGET}_{_}ₘᵢₙ and I₁, displayed as measured value 44 in FIG. 7. As a result of the release current I coming close to the specified target value I_{TARGET} in this manner, through the classification into region 25′ a proportion ΔI_{J1} that is smaller than ΔI_{J2} is selected in Step 35. Thus for the subsequent sixth adjustment step an adjustment current in accordance with I_{J}=I_{J0}+ΔI_{J3}+ΔI_{J3}+ΔI_{J3}+ΔI_{J2}+ΔI_{J1} is formed and the sixth adjustment step performed.

After this adjustment step the release current I measured in Step 34, displayed as measured value 45, still lies in the region 25′ between I_{TARGET}_{_}ₘᵢₙ and I₁. Thus for the subsequent seventh adjustment step an adjustment current in accordance with I_{J}=I_{J0}+ΔI_{J3}+ΔI_{J3}+ΔI_{J3}+ΔI_{J2}+ΔI_{J1}+ΔI_{J1} is formed and the seventh adjustment step performed with this adjustment current.

This seventh adjustment step has sufficiently demagnetised the permanent magnet 2 that, during the subsequent eighth measurement of the release current I, a value is determined which is displayed with the measurement point 46 and lies between I_{TARGET} and I_{TARGET}_{_}ₘₐₓ and hence in the specified tolerance range. Through the classification into region 21′, the method for adjustment of a magnetic release mechanism ends in Step 27′.

To illustrate the principles of the differential amounts ΔI_{J1}, ΔI_{J2}, ΔI_{J3} and ΔI_{J4} these have been displayed, by way of an example, in the top right of the diagram in FIG. 7, in a comparison with one another. In the example ΔI_{J4} is twice as large as ΔI_{J3}, ΔI_{J3} twice as large as ΔI_{J2} and ΔI_{J2} twice as large as ΔI_{J1}. These relationships of the differential amounts to one another are by way of examples and can be adapted individually by a person skilled in the art.

As can be discerned, when the release current I is brought close to the specified release target value I_{TARGET} as the procedure progresses smaller and smaller differential amounts are added to the adjustment current I_{J} selected in the previous adjustment step and used in the following adjustment step until the release current I lies within the tolerance range between I_{TARGET}_{_}ₘᵢₙ and I_{TARGET}_{_}ₘₐₓ. Here it may also be necessary to add on the same differential amount ΔI_{Jn} in two or more procedure run-throughs before a smaller differential amount ΔI_{Jn} can be selected.

As can also be discerned, the release current I is brought close to the specified target value I_{TARGET} particularly in region 16, which constitutes a region with high sensitivity for adjustment.

The partial demagnetisation of the permanent magnet 2 may, in a further variant, take place for example through oblique magnetisation of the permanent magnet 2. In order to carry out this oblique magnetisation, it is provided that the adjustment site 11 within the adjustment arrangement 10 is designed swivel- or tiltable. Thus the magnetic release mechanism 1 with its permanent magnet 2 can be moved out of its vertical position into an oblique position at an angle of for example κ, 10, 15, 30 or 45 degrees prior to carrying out an adjustment step.

The above embodiments are merely to illustrate the technical solutions of the present invention and are not intended to limit the present invention. Although the present invention has been described with reference to the above preferred embodiments, it should be appreciated by those skilled in the art that various modifications and variations may be made without departing from the spirit and scope of the present invention.

1. A method for adjusting a magnetic release mechanism (1), in which at least partial demagnetisation of a permanent magnet (2) arranged in the magnet release mechanism (1) takes place to achieve a specified release current, wherein an adjustment takes place automatically in one or more adjustment steps, whereby in a first step of the method a first measurement of the present release current I of the magnetic release mechanism (1) is carried out, whereby in a second step of the method, depending on this release current I measured, a decision is made as to whether an adjustment step is performed and that in the event that an adjustment step is necessary, a start-adjustment current I_{J0} is selected in a third step with which, in a fourth step of the method, the partial demagnetisation of the permanent magnet (2) is carried out in an adjustment step, that in a subsequent fifth step of the method a second measurement of the present release current I of the magnetic release mechanism (1) is carried out, that in a sixth step of the method, depending on this present measured release current I, a decision is made as to whether an adjustment step is performed and that in the event that an adjustment step is necessary, in a seventh step of the method a selection of a certain differential amount ΔI_{J} takes place, which is added in an eighth step of the method to the adjustment current I_{J} selected in the previous adjustment step, that in a ninth step of the method the further partial demagnetisation of the permanent magnet (2) is carried out in a further adjustment step with the adjustment current I_{J} formed in this way and that the steps five to nine of the method are carried out in succession until the release current I measured in the fifth step of the method lies within a specified range between I_{TARGET}_{_}ₘᵢₙ and I_{TARGET}_{_}ₘₐₓ.

2. The method of claim 1, wherein an adjustment takes place automatically in one adjustment step, whereby in a first step of the method a measurement of the present release current I of the magnetic release mechanism (1) is carried out, whereby in a second step of the method, depending on this release current I measured, a decision is made as to whether an adjustment step is undertaken and that in the event that an adjustment step is necessary, in a third step of the method a certain specified adjustment current I_{J}(28, 29, 30, 31) is selected to carry out the partial demagnetisation of the permanent magnet (2), that an adjustment step using the selected adjustment current I_{Jn} is carried out, that subsequently a new measurement of the present release current I of the magnetic release mechanism (1) is carried out and that an evaluation takes place as to whether the present release current I measured lies within a specified range between I_{TARGET}_{_}ₘᵢₙ and I_{TARGET}_{_}ₘₐₓ.

3. The method of claim 1, wherein the measurement and storage of the present release current I of the magnetic release mechanism (1) takes place at the time of the release of the magnetic release mechanism (1), whereby this time is recorded by a detection tool which recognises a movement of an armature (3) of the magnetic release mechanism (1) from an initial end position to a second end position and vice versa.

4. The method of claim 2, wherein a selection of the first adjustment current I_{J1} takes place in one step (28) in the event that it is determined in one step (22) that the release current I is larger than a current I₃ and smaller than a maximum current I₄, that a selection of a second adjustment current I_{J2} takes place in one step (29) in the event that it is determined in one step (23) that the release current I is larger than a current I₂ and smaller than a current I₃, that a selection of a third adjustment current I_{J3} takes place in one step (30) in the event that in one step (24) it is determined that the release current I is larger than a current I₁ and smaller than a current I₂ and that a selection of a fourth adjustment current I_{J4} in one step (31) takes place in the event that in one step (25) it is determined that the release current I is larger than a current I_{TARGET}_{_}ₘₐₓ and smaller than current I1, whereby I_{TARGET}_{_}ₘᵢₙ<I_{TARGET}<I_{TARGET}_{_}ₘₐₓ and I_{J4}<I_{J3}<I_{J2}<I_{J1}.

5. The method of claim 1, wherein a selection of a certain differential amount ΔI_{J} takes place from four differential amounts ΔI_{J1}, ΔI_{J2}, ΔI_{J3} or ΔI_{J4}, whereby a selection of a first differential amount ΔI_{J1} takes place in step (35) in the event that in one step (25′) it is determined that the release current I is larger than a current I_{TARGET}_{_}ₘₐₓ and smaller than a current I₁, that a selection of a second differential amount ΔI_{J2} in step (36) takes place in the event that in a step (24′) it is determined that the release current I is larger than a current I₁ and smaller than a current I₂, that a selection of a third differential amount ΔI_{J3} in step (37) takes place in the event that in a step (23′) it is determined that the release current I is larger than a current I₂ and smaller than a current I₃ and that a selection of a fourth differential amount ΔI_{J4} in step (38) takes place in the event that in a step (22′) it is determined that the release current I is larger than a current I₃ and smaller than a current I₄, whereby I_{TARGET}_{_}ₘᵢₙ<I_{targetTARGET}<I_{TARGET}_{_}ₘₐₓ and ΔI_{J1}<ΔI_{J2}<ΔI_{J3}<ΔI_{J4}.

6. The method of claim 1, wherein before every measurement of release current I the armature (3) of the magnetic release mechanism (1) is re-set from the second final position to the first final position, in which the armature (3) is held by the permanent magnet (2).

7. The method of claim 1, wherein the detection of the release of the magnetic release mechanism (1) takes place by means of a light barrier (12).

8. The method of claim 7, wherein by means of a control unit (13) a continually increasing release current I is provided for the magnetic release mechanism (1).

9. The method of claim 5, wherein the differential amount ΔI₄ is twice the size of the differential amount ΔI_{J3}, that the differential amount ΔI_{J3} is twice the size of the differential amount ΔI_{J2} and that the differential amount ΔI_{J2} is twice the size of the differential amount ΔI_{J1}.

10. The method of claim 1, wherein what is at least partial demagnetisation of the permanent magnet (2) is carried out by means of a current pulse with a decreasing amplitude, which flows through an adjustment coil (15).

11. The method of claim 2, wherein the measurement and storage of the present release current I of the magnetic release mechanism (1) takes place at the time of the release of the magnetic release mechanism (1), whereby this time is recorded by a detection tool which recognises a movement of an armature (3) of the magnetic release mechanism (1) from an initial end position to a second end position and vice versa.
